(19) United States
(12) Patent Application Publication
(10) Pub. No.: US 2009/0058293 A1
(43) Pub. Date: Mar. 5, 2009

(54) DISPLAY DEVICE

(76) Inventor: Norihisa Maeda, Ishikawa-gun (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/192,559

(22) Filed: Aug. 15, 2008

(30) Foreign Application Priority Data
Aug. 31, 2007 (JP) 2007-226128
May 21, 2008 (JP) 2008-133433

(51) Int. Cl. H01J 1/62

(52) U.S. Cl. 313/512

(57) ABSTRACT

A display device includes an array substrate having a self-luminous element in a display area, a sealing substrate which is disposed to be opposed to the self-luminous element side of the array substrate, a sealant which is disposed in a frame shape in a manner to surround the display area, and attaches the array substrate and the sealing substrate, a signal supply wiring which is disposed in the display area, extends under the sealant, and is led out to an extension portion of the array substrate, which extends outward from an end portion of the sealing substrate, and a protection film which is disposed to cover the self-luminous element, wherein the protection film is disposed to further cover the signal supply wiring which is opposed to the end portion of the sealing substrate on an outside of the sealant.

### CROSS-REFERENCE TO RELATED APPLICATIONS

This application is based upon and claims the benefit of priority from prior Japanese Patent Applications No. 2007-226128, filed Aug. 31, 2007; and No. 2008-133433, filed May 21, 2008, the entire contents of both of which are incorporated herein by reference.

### BACKGROUND OF THE INVENTION

1. Field of the Invention

The present invention relates to a display device, and more particularly to a display device which is configured to include a self-luminous display element.

2. Description of the Related Art

In recent years, organic electroluminescence (EL) display devices have attracted attention as flat-panel display devices. Since the organic EL display device includes an organic EL element which is a self-luminous element, it has such features as a wide viewing angle, small thickness without a need for backlight, low power consumption, and a high responsivity speed. For these features, attention has been paid to the organic EL display device as a promising candidate for the next-generation flat-panel display device, which will take the place of liquid crystal display devices.

The organic EL element is configured such that an organic active layer containing an organic compound with a light-emitting function is held between an anode and a cathode. However, materials which are used for the organic EL element, in particular, materials which form the organic active layer, include a material which easily deteriorates due to moisture or oxygen. Thus, the organic EL element is airtightly sealed by a sealing substrate which is disposed to be opposed to an array substrate.

A terminal section for connecting a signal supply source to the array substrate is provided so as to be exposed from an end portion of the sealing substrate. Accordingly, a part of the sealing substrate, which overlaps the terminal section of the array substrate, is removed. For example, a technique is disclosed wherein in an organic EL element in which a sealing film for sealing a light emission section formed on a substrate is formed, a laser beam is applied to the sealing film in which an organic film and an inorganic film are stacked, thereby removing the sealing film and exposing a terminal section (see Jpn. Pat. Appln. KOKAI Publication No. 2006-066364). Aside from this technique, there is known a technique wherein a sealing substrate, which is formed of a glass substrate, is bonded to an array substrate, and then the part of the sealing substrate, which overlaps a terminal section, is cut and removed.

The array substrate includes a signal supply wiring which is connected to the terminal section. The signal supply wiring is a wiring for supplying various signals or power from a signal supply source to the organic EL element. When the sealing substrate, which overlaps the terminal section on the array substrate having the above-described structure is cut out, an unnecessary cut-out portion may, in some cases, come in contact with the signal supply wiring on the array substrate, and may cause breakage of the signal supply wiring. This may lead to a decrease in manufacturing yield of display devices.

### BRIEF SUMMARY OF THE INVENTION

The present invention has been made in consideration of the above-described problem, and the object of the invention is to provide a display device which can prevent a decrease in manufacturing yield, without increasing the manufacturing cost and the number of fabrication steps.

According to a first aspect of the present invention, there is provided a display device comprising: an array substrate having a self-luminous element in a display area; a sealing substrate which is disposed to be opposed to the self-luminous element side of the array substrate; a sealant which is disposed in a frame shape in a manner to surround the display area, and attaches the array substrate and the sealing substrate; a signal supply wiring which is disposed in the display area, extends under the sealant, and is led out to an extension portion of the array substrate, which extends outward from an end portion of the sealing substrate; and a protection film which is disposed to cover the self-luminous element, wherein the protection film is disposed to further cover the signal supply wiring which is opposed to the end portion of the sealing substrate on an outside of the sealant.

According to a second aspect of the present invention, there is provided a display device comprising: an array substrate having a self-luminous element which is disposed in a display area, and having a protection film which is formed of an inorganic material and disposed in a manner to cover the self-luminous element; a sealing substrate which is disposed to be opposed to the self-luminous element side of the array substrate; a sealant which is formed of frit glass, is disposed in a frame shape in a manner to surround the display area, and attaches the array substrate and the sealing substrate; a signal supply wiring which is disposed in the display area, extends under the sealant, and is led out to an extension portion of the array substrate, which extends outward from the sealing substrate, wherein the protection film is further disposed between the signal supply wiring and the sealant in such a manner that the protection film is in contact with the sealant.

The present invention can provide a display device which can prevent a decrease in manufacturing yield, without increasing the manufacturing cost and the number of fabrication steps.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the structure of an organic EL display device according to an embodiment of the present invention;

FIG. 2 is a cross-sectional view schematically showing an example of the cross-sectional structure of the organic EL display device shown in FIG. 1;

FIG. 3A is a cross-sectional view schematically showing an example of the cross-sectional structure of an organic EL display device according to a first embodiment of the invention;

FIG. 3B schematically shows the structure of a part of a display area of the organic EL display device shown in FIG. 3A;

FIG. 4A is a cross-sectional view schematically showing the cross-sectional structure of an organic EL display device according to a second embodiment of the invention;

FIG. 4B is a cross-sectional view schematically showing the cross-sectional structure of an organic EL display device according to a modification of the second embodiment;

FIG. 5 is a cross-sectional view schematically showing the cross-sectional structure of an organic EL display device according to a third embodiment of the invention;

FIG. 6 is a cross-sectional view schematically showing the cross-sectional structure of an organic EL display device according to a fourth embodiment of the invention; and

FIG. 7 is a cross-sectional view schematically showing the cross-sectional structure of an organic EL display device according to a modification of the embodiments.

### DETAILED DESCRIPTION OF THE INVENTION

A display device according to an embodiment of the present invention will now be described with reference to the accompanying drawings. In this embodiment, a self-luminous display device, for instance, an organic EL (electroluminescence) display device, is described as an example of the display device.

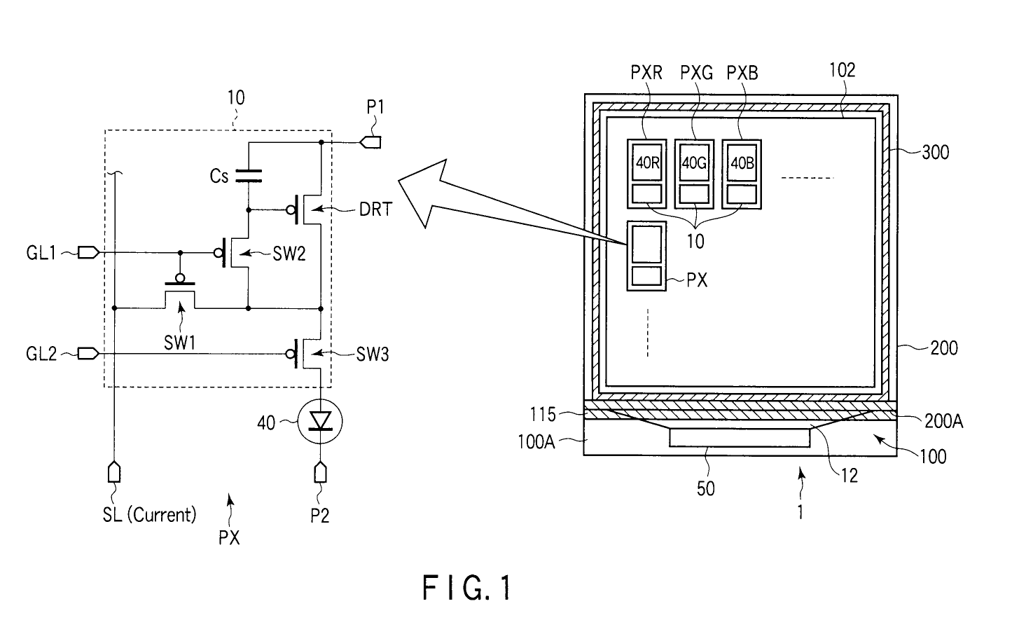

As shown in FIG. 1, an organic EL display device 1 includes an array substrate 100 having a display area 102 which displays an image. The display area 102 is composed of a plurality of pixels PX which are arrayed in a matrix. FIG. 1 shows the organic EL display device 1 of a color display type, by way of example, and the display area 102 is composed of a plurality of kinds of color pixels, for instance, a red pixel PXR, a green pixel PXG and a blue pixel PXB corresponding to the three primary colors.

Each of the pixels PX (R, G, B) includes a pixel circuit 10 and a display element 40 which is driven and controlled by the pixel circuit 10. Needless to say, the pixel circuit 10 shown in FIG. 1 is merely an example, and pixel circuits with other structures are applicable. In the example shown in FIG. 1, the pixel circuit 10 is configured to include a driving transistor DRT, a first switch SW1, a second switch SW2, a third switch SW3 and a storage capacitance element Cs. The driving transistor DRT has a function of controlling the amount of electric current that is supplied to the display element 40. The first switch SW1 and the second switch SW2 function as a sample/hold switch. The third switch SW3 has a function of controlling the supply of driving current from the driving transistor DRT to the display element 40, that is, the turning on/off of the display element 40. The storage capacitance element Cs has a function of retaining a gate-source potential of the driving transistor DRT.

The driving transistor DRT is connected between a high-potential power supply line P1 and the third switch SW3. The display element 40 is connected between the third switch SW3 and a low-potential power supply line P2. The gate electrodes of the first switch SW1 and second switch SW2 are connected to a first gate line GL1. The gate electrode of the third switch SW3 is connected to a second gate line GL2. The source electrode of the first switch SW1 is connected to a video signal line SL. The driving transistor DRT, first switch SW1, second switch SW2 and third switch SW3 are composed of, for example, thin-film transistors, and their semiconductor layers are formed of polysilicon in this example.

In the case of this circuit structure, the first switch SW1 and the second switch SW2 are turned on, on the basis of the supply of an ON signal from the first gate line GL1. An electric current flows from the high-potential power supply line P1 to the driving transistor DRT in accordance with the amount of electric current flowing in the video signal line SL, and the storage capacitance element Cs is charged in accordance with the electric current flowing in the driving transistor DRT. Thereby, the driving transistor DRT can supply from the high-potential power supply line P1 to the display element 40 the same amount of electric current as the electric current that is supplied from the video signal line SL.

On the basis of the supply of the ON signal from the second gate line GL2, the third switch SW3 is turned on, and the driving transistor DRT supplies a predetermined amount of current corresponding to a predetermined luminance from the high-potential power supply line P1 to the display element 40 via the third switch SW3 in accordance with the capacitance that is retained in the storage capacitance element Cs. Thereby, the display element 40 emits light with a predetermined luminance.

The display element 40 is composed of the organic EL element 40 (R, G, B) that is a self-luminous element. Specifically, the red pixel PXR includes an organic EL element 40R which mainly emits light corresponding to a red wavelength. The green pixel PXG includes an organic EL element 40G which mainly emits light corresponding to a green wavelength. The blue pixel PXB includes an organic EL element 40B which mainly emits light corresponding to a blue wavelength.

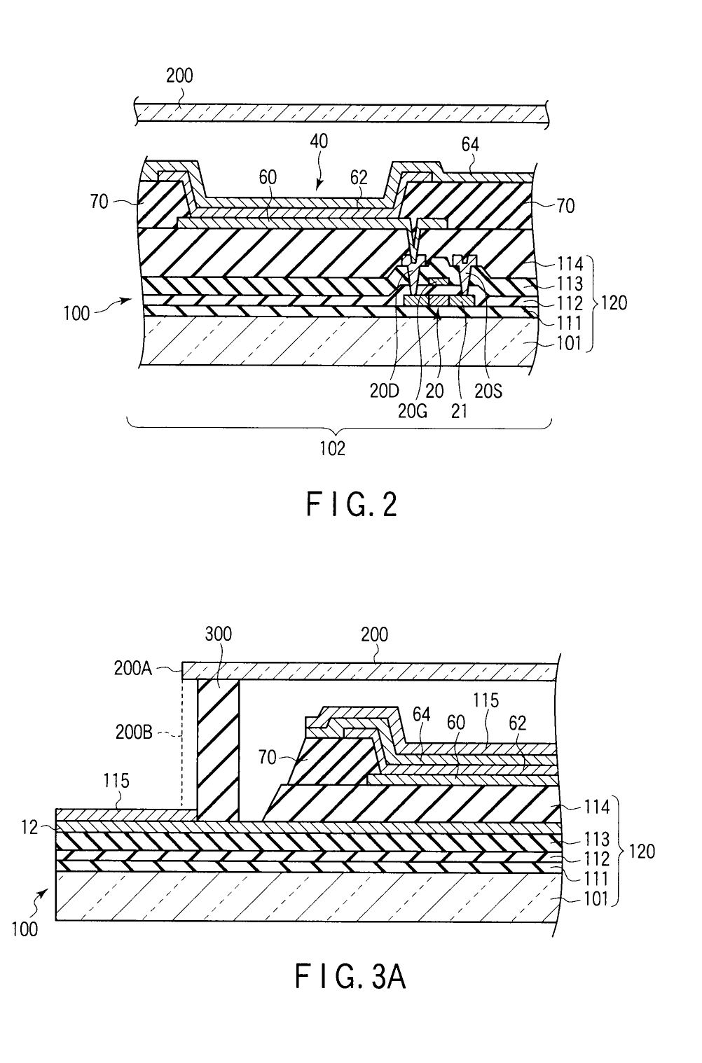

The respective kinds of organic EL elements 40 (R, G, B) have basically the same structure. For example, as shown in FIG. 2, the organic EL element 40 (R, G, B) is disposed on a wiring substrate 120. The wiring substrate 120 is configured such that insulation layers, such as an undercoat layer 111, a gate insulation film 112, an interlayer insulation film 113 and an organic insulation film 114, as well as the various switches SW, driving transistor DRT, storage capacitance element Cs and various signal supply wiring (gate line GL, video signal line SL, power line P, etc.) 12, are provided on an insulative support substrate 101 such as a glass substrate or a plastic sheet. The undercoat layer 111, gate insulation film 112 and interlayer insulation film 113 are formed of an inorganic material such as silicon oxide (SiO₂) or silicon nitride (SiNx). The organic insulation film 114 is formed by patterning an insulative resin material. Where necessary, a passivation film, which is formed of an inorganic material such as silicon oxide or silicon nitride, may be disposed between the interlayer insulation film 113 and the organic insulation film 114.

Specifically, in the example shown in FIG. 2, a semiconductor layer 21 of a transistor element (the third switch SW3 in the circuit structure shown in FIG. 1) 20, such as a switch or a driving transistor, is disposed on the undercoat layer 111. The semiconductor layer 21 is covered with the gate insulation film 112. A gate electrode 20G of the transistor element 20 is disposed on the gate insulation film 112. The gate electrode 20G is covered with the interlayer insulation film 113. A source electrode 20S and a drain electrode 20D of the transistor element 20 are disposed on the interlayer insulation film 113. The source electrode 20S and drain electrode 20D are put in contact with the semiconductor layer 21 via contact holes which penetrate the gate insulation film 112 and interlayer insulation film 113 and reach the semiconductor layer 21. The source electrode 20S and drain electrode 20D are covered with the organic insulation film 114.

The organic EL element 40 comprises a first electrode 60 which is disposed in an independent island shape in association with each pixel PX; a second electrode 64 which is disposed to be opposed to the first electrode 60 and is disposed common to a plurality of color pixels PX; and an organic active layer 62 which is held between the first electrode 60 and the second electrode 64.

The first electrode 60 is disposed on the organic insulation film 114, which is the surface of the wiring substrate 120, and functions as an anode. The first electrode 60 is connected to the drain electrode 20D of the transistor element 20 via a contact hole formed in the organic insulation film 114. In the case of a top emission method, the first electrode 60 should preferably include a reflective layer. For example, the first electrode 60 may be composed of a multilayer structure in which a transmissive layer that is formed of a light-transmissive, electrically conductive material such as indium tin oxide (ITO) and a reflective layer that is formed of a light-reflective, electrically conductive material such as aluminum (Al) or silver (Ag) are stacked, or the first electrode 60 may be composed of, for example, a single reflective layer or a single transmissive layer.

The organic active layer 62 is disposed on the first electrode 60 and includes at least a light-emitting layer. The organic active layer 62 may include, in addition to the light-emitting layer, other functional layers, for instance, a hole transport layer, a hole injection layer, a blocking layer, an electron transport layer, an electron injection layer, and a buffer layer. Alternatively, the organic active layer 62 may be composed of a single layer in which a plurality of functional layers are combined, or may be composed of a multilayer structure in which functional layers are stacked. In the organic active layer 62, it should suffice if the light-emitting layer is formed of an organic material, and the layers other than the light-emitting layer may be formed of either an inorganic material or an organic material. In the organic active layer 62, the functional layers other than the light-emitting layer may be a common layer. The light-emitting layer is formed of an organic compound having a function of emitting red, green or blue light. The organic active layer 62 may include a thin film which is formed of a high molecular weight material. Such a thin film may be formed by a selective coating method such as an ink jet method. Besides, the organic active layer 62 may include a thin film which is formed of a lower molecular weight material. Such a thin film may be formed by a method such as a mask evaporation deposition method.

The second electrode 64 is disposed so as to cover the organic active layer 62 and functions as a cathode. The second electrode 64 may include a semi-transmissive layer. Specifically, the second electrode 64 may be composed of a multilayer structure in which a transmissive layer, which is formed of a light-transmissive, electrically conductive material such as ITO, and a semi-transmissive layer, which is formed of a mixture of silver (Ag) and magnesium (Mg), are stacked. Alternatively, the second electrode 64 may be formed of a single semi-transmissive layer. Needless to say, the second electrode 64 may be composed of a single transmissive layer. The second electrode 64 is connected to the low-potential power supply line P2.

The organic EL element 40 is covered with a protection film 115. Specifically, the second electrode 64 is covered with the protection film 115. The protection film 115 includes at least a film which is formed of an inorganic material such as silicon nitride (SiNx), silicon oxide (SiO₂) or silicon oxynitride (SiON). The protection film 115, which is formed of the above-mentioned inorganic material with the same refractive index as that of the second electrode 64, can also function as a light-path adjustment layer which optimizes the optical path length in realizing a micro-cavity structure.

The array substrate 100 includes, in the display area 102, partition walls 70 which isolate the pixels PX (R, G, B). The partition walls 70 are disposed in lattice shapes or in stripe shapes so as to cover peripheral edges of the first electrode 60. The partition walls 70 are formed by patterning an insulative resin material. In addition, the partition walls 70, together with the organic active layer 62, are covered with the second electrode 64.

At least the display area 102 of the array substrate 100 is sealed by a sealing substrate 200. Specifically, the sealing substrate 200 is disposed to be opposed to the organic EL element 40 side of the array substrate 100. The array substrate 100 and the sealing substrate 200 are attached to each other via a sealant 300 which is disposed in a frame shape so as to surround the display area 102. The sealant 300 may be a photosensitive resin (e.g. ultraviolet-curing resin) or frit glass. Thereby, the organic EL element 40 is sealed in an airtight space. In the case of the top emission type, a desiccating agent (not shown) may be disposed on the inner surface of the sealing substrate 200 (i.e. on that surface of the sealing substrate 200, which faces the array substrate 100) between the sealant 300 and the display area 102.

Further, as shown in FIG. 1, the array substrate 100 includes a terminal section 50 on the outside of the display area 102. The terminal section 50 is disposed on an extension portion 100A on the front surface side of the array substrate 100 (i.e. the side on which the pixels PX, etc. are disposed), the extension portion 100A extending outward from an end portion 200A of the sealing substrate 200. Various signal supply wiring 12 (gate line GL, video signal line SL, power line P, etc.), which is disposed on the display area 102, extends under the sealant 300 which couples the array substrate 100 and sealing substrate 200, and is led out to the extension portion 100A and connected to the terminal section 50. A signal supply source, such as a driving IC chip or a flexible printed circuit (FPC), which outputs a driving signal necessary for driving the pixels PX, is connected to the terminal section 50.

### First Embodiment

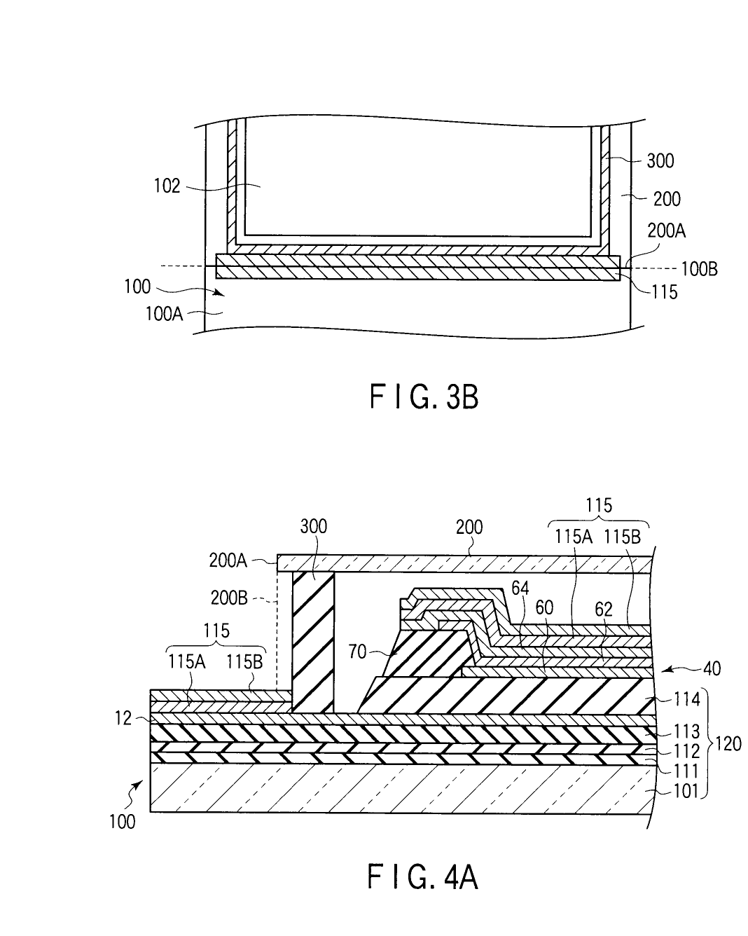

In a first embodiment of the invention, as shown in FIG. 3A, the protection film 115 further covers, on the outside of the sealant 300, the surface of the signal supply wiring 12, which is opposed to the end portion 200A of the sealing substrate 200. As shown in FIG. 3B, the protection film 115 is disposed on the signal supply wiring 12 on an intersection line 100B between an extension plane 200B, which extends from the end portion 200A of the sealing substrate 200 in the normal direction of the sealing substrate 200, and the array substrate 100. In other words, the protection film 115 is disposed with a predetermined width including the intersection line 100B. In the case where the distance between the end portion 200A and the sealant 300 is short, it is preferable to dispose the protection film 115 in contact with the sealant 300. In the first embodiment, both the protection film 115 covering the organic EL element 40 and the protection film 115 covering the signal supply wiring 12 are formed of an inorganic material.

According to the first embodiment, when the sealing substrate 200, which overlaps the terminal section 50 on the array substrate 100, is cut, the signal supply wiring 12 is protected since the signal supply wiring 12 that is opposed to the end portion 200A of the sealing substrate 200, which becomes the cut surface, is covered with the protection film 115. In other words, even if the cut-out unnecessary portion comes in contact with the array substrate 100, the protection film 115 prevents the unnecessary portion from coming in contact with the signal supply wiring 12, and breakage of the signal supply wiring 12 can be prevented.

In addition, since the protection film 115 on the organic EL element 40 and the protection film 115 on the signal supply wiring 12 are formed of the same material, the protection film 115 can be formed on the signal supply wiring 12 at the same time as the step of forming the protection film 115 on the organic EL element 40. The formation of the protection film 115 is performed by, e.g. mask evaporation deposition. By using a mask having openings at parts corresponding to both the display area 102 and the signal supply wiring 12, the protection film 115 can be formed on the organic EL element 40 and signal supply wiring 12 in the same fabrication step. Thus, there is no need to use another material for the protection film 115 covering the signal supply wiring 12, and there is no need to provide an additional fabrication step of depositing, by evaporation, the protection film 115 which covers the signal supply wiring 12.

Therefore, according to the first embodiment, without increasing the manufacturing cost and the number of fabrication steps, breakage of the signal supply wiring 12 can be prevented and a decrease in manufacturing yield can be prevented.

### Second Embodiment

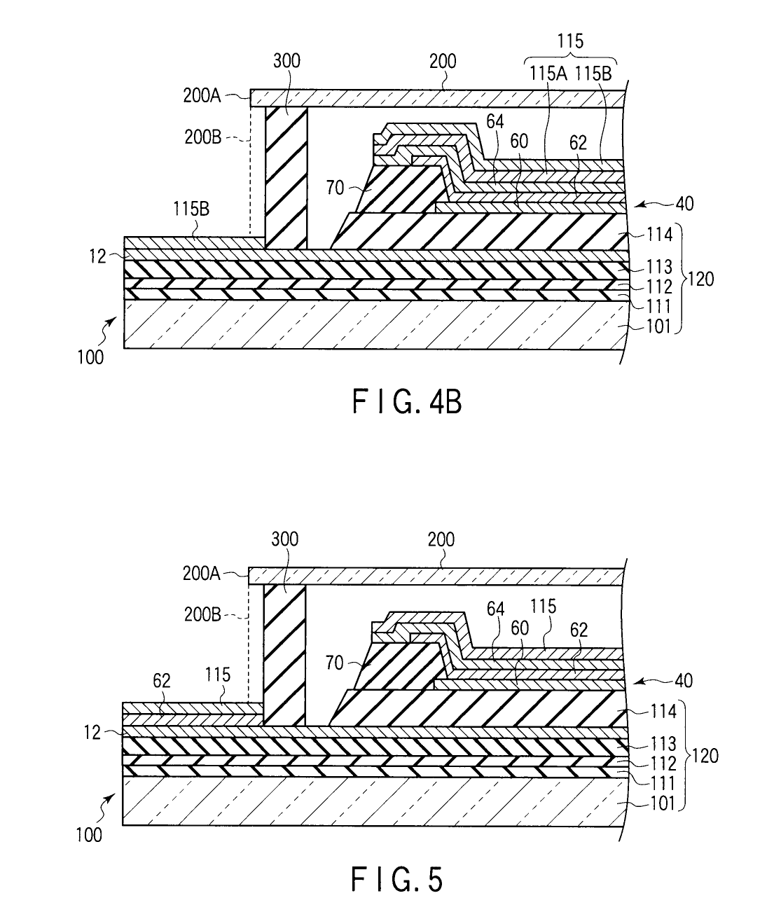

In a second embodiment of the invention, as shown in FIG. 4A, the protection film 115 covers, on the outside of the sealant 300, the surface of the signal supply wiring 12, which is opposed to the end portion 200A of the sealing substrate 200. Like the first embodiment, the protection film 115 is disposed on the signal supply wiring 12 on the intersection line 100B between the extension plane 200B, which extends from the end portion 200A of the sealing substrate 200 in the normal direction of the sealing substrate 200, and the array substrate 100.

In the second embodiment, each of the protection film 115 covering the organic EL element 40 and the protection film 115 covering the signal supply wiring 12 is formed of a multiplayer structure comprising a protection film (organic layer) 115A of an organic material and a protection film (inorganic layer) 115B of an inorganic material which is stacked on the protection film 115A. Although FIG. 4A shows the two-layer protection film 115, use may be made of a protection film 115 in which a plurality of organic layers and inorganic layers are alternately stacked.

Even in the case where the protection film 115 is formed as described above, breakage of the signal supply wiring 12 can be prevented, as in the first embodiment. In the second embodiment, since the protection film 115 covering the signal supply wiring 12 is formed of the multiplayer structure comprising the protection film 115A of the organic material and the protection film 115B of the inorganic material, the thickness of the protection film 115 increases. Accordingly, breakage of the signal supply wiring 12 can more effectively be prevented.

In addition, the protection film 115 on the organic EL element 40 and the protection film 115 on the signal supply wiring 12 are formed of the same material in the same fabrication step. Therefore, according to the second embodiment, like the first embodiment, breakage of the signal supply wiring 12 can be prevented and a decrease in manufacturing yield can be prevented without increasing the manufacturing cost and the number of fabrication steps.

### Modification of the Second Embodiment

In a modification of the second embodiment, as shown in FIG. 4B, the protection film 115 covering the organic EL element 40 is formed of a protection film 115A of an organic material and a protection film 115B of an inorganic material, as in the second embodiment. On the other hand, the protection film 115 covering the signal supply wiring 12 is formed of only a protection film 115B of an inorganic material. With the use of this protection film 115, the same advantageous effects as in the second embodiment can be obtained.

### Third Embodiment

In a third embodiment of the invention, as shown in FIG. 5, the protection film 115 covers, on the outside of the sealant 300, the surface of the signal supply wiring 12, which is opposed to the end portion 200A of the sealing substrate 200. In addition, the organic active layer 62 covers, on the outside of the sealant 300, the surface of the signal supply wiring 12. In other words, the organic active layer 62 is disposed between the signal supply wiring 12 and the protection film 115. The protection film 115 and the organic active layer 62 are disposed on the signal supply wiring 12 on the intersection line 100B between the extension plane 200B, which extends from the end portion 200A of the sealing substrate 200 in the normal direction of the sealing substrate 200, and the array substrate 100. The organic active layer 62, which is disposed between the signal supply wiring 12 and the protection film 115, also functions substantially as a protection film for protecting the signal supply wiring 12.

In the third embodiment, the protection film 115 covering the organic EL element 40 and the protection film 115 covering the signal supply wiring 12 may be formed of only an inorganic material, or of a multilayer structure of an inorganic material and an organic material. No matter which kind of protection film 115 is used, the signal supply wiring 12 is covered with the organic active layer 62 as well as the protection film 115. Accordingly, the thickness of the protection film 115 that covers the signal supply wiring 12 increases, and breakage of the signal supply wiring 12 can more effectively be prevented. In the meantime, the organic active layer 62, which is disposed between the signal supply wiring 12 and the protection film 115, may be formed by stacking the organic active layer 62 that is disposed in the color pixel of red, green or blue, and thereby the film thickness can further be increased.

The protection film 115 on the organic EL element 40 and the protection film 115 on the signal supply wiring 12 are formed of the same material in the same fabrication step. In addition, in the case where the organic active layer 62 is formed of a low molecular weight material, the organic active layer 62, like the protection film 115, can be formed by mask evaporation deposition, and thus the organic active layer 62 of the organic EL element 40 and the organic active layer 62 on the signal supply wiring 12 are formed of the same material. Therefore, according to the third embodiment, like the first embodiment, breakage of the signal supply wiring 12 can be prevented and a decrease in manufacturing yield can be prevented without increasing the manufacturing cost and the number of fabrication steps.

The above-described first to third embodiments are applicable to not only to the case where the sealant 300 is a photosensitive resin, but also to the case where the sealant is frit glass.

### Fourth Embodiment

A fourth embodiment of the invention relates to a structure which is suited to the case where the sealant 300 is frit glass (“frit seal”). Specifically, the array substrate 100 and the sealing substrate 200 are attached by the frame-shaped sealant 300 which surrounds the display area 102.

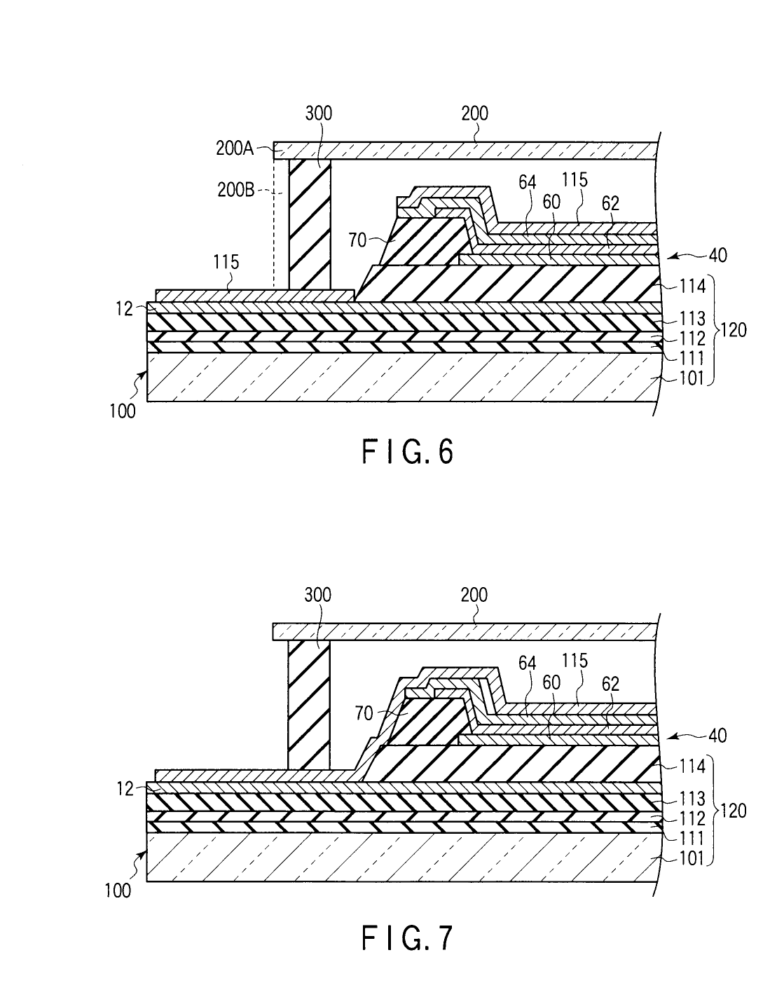

In the fourth embodiment, as shown in FIG. 6, in the region where the sealant 300 is formed, the protection film 115 lies between the signal supply wiring 12 and the sealant 300 and is disposed in contact with the sealant 300. In particular, in the fourth embodiment, the protection film 115 is formed of an inorganic material.

In the structure in which the sealant 300 of frit glass is used, high airtightness is required. Therefore, the adhesiveness of the sealant 300 with the array substrate 100 is very important. According to the inventor's study, it was found that the frit glass has low adhesiveness with a metal that is a wiring material.

Thus, in the present embodiment, a protection film 115 of an inorganic material is used as an underlayer of the sealant 30 that is formed of frit glass, and the sealant 300 is disposed in contact with the protection film 115. Accordingly, the sealant 300 and the protection film 115 are put in close contact. Thereby, the array substrate 100 and the sealing substrate 200 are airtightly attached, and inflow of moisture or oxygen can be prevented. Therefore, according to the fourth embodiment, degradation of the organic EL element 40 can be prevented, and a decrease in manufacturing yield can be prevented.

Furthermore, in the example shown in FIG. 6, the protection film 115 extends to the outside of the sealant 300 and covers the surface of the signal supply wiring 12 which is opposed to the end portion 200A of the sealing substrate 200. If the protection film 115 is formed in this manner, like the first embodiment, breakage of the signal supply wiring 12 can be prevented.

In the case of the frit seal, frit glass is heated and melted, for example, by irradiation of a laser beam, and thereby the array substrate 100 and the sealing substrate 200 are attached. In the fourth embodiment, the signal supply wiring 12, which is disposed under the sealant 300, is covered with the protection film 115 that is formed of an inorganic material (e.g. SiON) with a relatively high heat resistance. It is possible, therefore, to reduce the damage to the signal supply wiring 12 due to the heat that is produced when the sealant 300 is melted.

In the display area 102, insulation layers of organic materials, such as the organic insulation film 114 and partition wall 70, are stacked on the sealing substrate side of the signal supply wiring 12. Such insulation layers of organic materials have a relatively low heat resistance and have a lower adhesiveness with frit glass than inorganic materials. Taking this into account, the organic insulation film 114 and partition wall 70 are disposed inside the sealant 300. In short, in the present embodiment in which the frit seal is applied, the insulation film of organic material neither forms the protection film 115 that comes in contact with the sealant 300, nor lies between the protection film 115 and the signal supply wiring 12.

The protection film 115 on the organic EL element 40 and the protection film 115 on the signal supply wiring 12 are formed of the same material in the same fabrication step. Therefore, according to the fourth embodiment, inflow of moisture or oxygen and breakage of the signal supply wiring 12 can be prevented and a decrease in manufacturing yield can be prevented without increasing the manufacturing cost and the number of fabrication steps.

In the above-described first to fourth embodiments, as shown in FIG. 7, the protection film 115 covering the organic EL element 40 and the protection film 115 covering the signal supply wiring 12 may be integrally formed. In this case, the protection film 115 is disposed to extend under the sealant 300 and to cover the signal supply wiring 12.

In addition, on the outside of the sealant 300, a layer which is stacked above the signal supply wiring 12, for instance, the organic insulation film 114 or a passivation film (not shown) formed of an inorganic material, may be disposed between the signal supply wiring 12 and the protection film 115. Thereby, it becomes possible to obtain a protection film 115 with a thickness enough to protect the signal supply wiring 12, without increasing a process load.

As has been described above, according to the display device of the embodiment, a decrease in manufacturing yield can be prevented without increasing the manufacturing cost and the number of fabrication steps.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display device comprising:
an array substrate having a self-luminous element in a display area;
a sealing substrate which is disposed to be opposed to the self-luminous element side of the array substrate;
a sealant which is disposed in a frame shape in a manner to surround the display area, and attaches the array substrate and the sealing substrate;
a signal supply wiring which is disposed in the display area, extends under the sealant, and is led out to an extension portion of the array substrate, which extends outward from an end portion of the sealing substrate; and
a protection film which is disposed to cover the self-luminous element,
wherein the protection film is disposed to further cover the signal supply wiring which is opposed to the end portion of the sealing substrate on an outside of the sealant.

2. The display device according to claim 1, wherein the protection film is formed of an inorganic material.

3. The display device according to claim 1, wherein the protection film is formed such that an inorganic material and an organic material are stacked.

4. The display device according to claim 1, wherein the protection film, which covers the self-luminous element, is formed such that an inorganic material and an organic material are stacked, and
the protection film, which covers the signal supply wiring, is formed of an inorganic material.

5. The display device according to claim 1, wherein the sealant is formed of frit glass, and
the protection film, which covers the signal supply wiring, is formed of an inorganic material and is disposed between the sealant and the signal supply wiring.

6. The display device according to claim 1, wherein the self-luminous element comprises:
a first electrode which is disposed in each of pixels;
an organic active layer which is disposed on the first electrode; and
a second electrode which is disposed on the organic active layer,
wherein the organic active layer is further disposed between the signal supply wiring and the protection film on the outside of the sealant.

7. A display device comprising:
an array substrate having a self-luminous element which is disposed in a display area, and having a protection film which is formed of an inorganic material and disposed in a manner to cover the self-luminous element;
a sealing substrate which is disposed to be opposed to the self-luminous element side of the array substrate;
a sealant which is formed of frit glass, is disposed in a frame shape in a manner to surround the display area, and attaches the array substrate and the sealing substrate; and
a signal supply wiring which is disposed in the display area, extends under the sealant, and is led out to an extension portion of the array substrate, which extends outward from the sealing substrate,
wherein the protection film is further disposed between the signal supply wiring and the sealant in such a manner that the protection film is in contact with the sealant.

8. The display device according to claim 7, wherein the protection film is further disposed to cover the signal supply wiring which is opposed to an end portion of the sealing substrate on an outside of the sealant.

9. The display device according to claim 8, wherein the self-luminous element comprises:
a first electrode which is disposed in each of pixels;
an organic active layer which is disposed on the first electrode; and
a second electrode which is disposed on the organic active layer,
wherein the organic active layer is further disposed between the signal supply wiring and the protection film on the outside of the sealant.
